(19) United States
(12) Patent Application Publication
(10) Pub. No.: US 2005/0271354 A1
(43) Pub. Date: Dec. 8, 2005

(54) Card for video/audio recording and playback

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/860,004

(22) Filed: Jun. 4, 2004

(51) Int. Cl. H04N 5/76; H04N 5/225

(52) U.S. Cl. 386/46; 386/117

(57) ABSTRACT

A card for video/audio recording and playback, wherein a machine is combined with the card. A recording device, a playback device, and a storage device are located on the machine. By the use of the recording device the card sender can record his image and voice at any time to provide a card with stereophonic and dynamic image and voice, so as to convey the card sender's greeting lively. In addition, by the use of the playback device a lively linkage is produced between the card sender and receiver so as to provide the card receiver with a live reality feeling, as face to face, and to provide an impressive convey method. The card receiver can store the file recorded by the card sender for editing, modifying, and utilizing through the storage device.

### FIELD OF THE INVENTION

The present invention relates to a card for video/audio recording and playback, and more particularly, to a card for video/audio recording and playback which is capable of stereophonic and dynamic transmitting video and audio.

### BACKGROUND OF THE INVENTION

Usually, people presented relatives and friends with greetings by sending cards in special days. However, even if a birthday card, Christmas card, or any kind of universal card, the traditional card provides merely the way of writing wishes and messages down by text to convey card sender's intention. But, the planar and static expression with text is rigid, emotionless, and has no reality, so the card receiver cannot have impressive feeling as face to face. Hence, none of these cards meets requirements of user.

There is another kind of traditional card, i.e. music card. Although the music card shows sounds, for example, the playing of a birthday song, to express wish by sound besides text, the music showed by the music card is monotonic and unchangeable. Moreover, the showed music is pre-recorded by card manufacturer and is not card sender's voice. It does not convey greetings according to the card sender's demand. The expression of the music card is emotionless, and is composed of formulated monotonic sound. Accordingly, the music card does not meet demands of user in actual use.

### SUMMARY OF THE INVENTION

One aspect of the present invention is to provide a card for video/audio recording and playback which is capable of recording, storing, and showing card sender's image and voice for promoting a traditional communicating way with planar static text to a stereophonic and dynamic communicating way, so as to provide the card receiver with live reality feeling, as if receiving a greeting and communication face to face, and to achieve a lively and impressive conveyance effect.

Another aspect of the present invention is to provide a card for video/audio recording and playback, wherein the card includes a storage device to store the recorded image and voice file. This file can be edited or changed by computer or other electronic equipment at any time to resolve the deficiency of traditional music card in which the music content is un-changeable.

It is still another aspect of the present invention to provide a card for video/audio recording and playback, wherein the video/audio recording machine can be demounted separately to re-use, and the purpose of various utilizations is thus achieved.

According to the aforementioned aspect of the present invention, there is provided a card for video/audio recording and playback, wherein a machine is fixed on the card, the machine comprises a recording device, a playback device, and a storage device, the recording device comprises a microphone, a camera lens, and a set of recording button for enabling the card sender to pre-record the demanded voice and image as greeting. The playback device comprises a playback button, a speaker, and a monitor to show the video/audio pre-recorded by the card sender. The storage device can be an external memory card for storing the recorded video/audio file and for further editing, modifying, and utilizing by computer. In addition, the card can also show file that is stored in other electronic equipment by the use of storage device.

Accordingly, a stereophonic and dynamic card which is capable of showing text, voice, and image is provided, the card sender's voice and image can be sent to convey a more emotional and lively greeting and produce a reality condition as face to face for touching card receiver deeply in the heart. The machine of the present invention can be fixed to the card by adhesion. Hence, the machine can be demounted from the card and re-used in other conditions to bring capability into fully play. In addition, by the use of the storage device the card receiver can store the valuable video/audio file that is sent by the card sender in the computer for editing/modifying and providing the capabilities of content re-recording and replacing to have various applications.

The foregoing aspects and many of the attendant advantages of this invention will become more readily appreciated as the same becomes better understood by reference to the following detailed description, when taken in conjunction with the accompanying drawings.

It is intended that various modifications and similar arrangements be included within the spirit of the present invention. The illustrated preferred embodiment of the present invention will be described fully in the following detailed description and the structures of the preferred embodiment are shown in the accompanying drawings.

### BRIEF DESCRIPTION OF THE DRAWINGS

FIG. 1 is a schematic, elevational view of the present invention.

FIG. 2 is a schematic, lateral view showing the combination of machine and card of the present invention.

FIG. 3 is a schematic diagram showing a second preferred embodiment of the present invention.

FIG. 4 is a schematic diagram showing the closed card in accordance with a second preferred embodiment of the present invention.

FIG. 5 is a schematic diagram showing the third preferred embodiment of the present invention.

FIG. 6 is a schematic diagram showing the closed card in accordance with a third preferred embodiment of the present invention.

FIG. 7 is a schematic diagram showing a fourth preferred embodiment of the present invention.

FIG. 8 is a schematic diagram showing a fifth preferred embodiment of the present invention.

### DETAILED DESCRIPTION OF THE PREFERRED EMBODIMENT

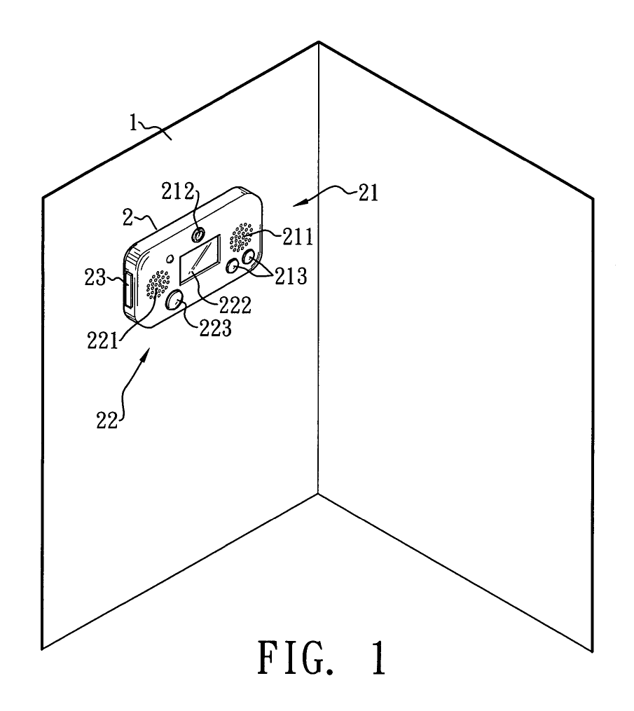

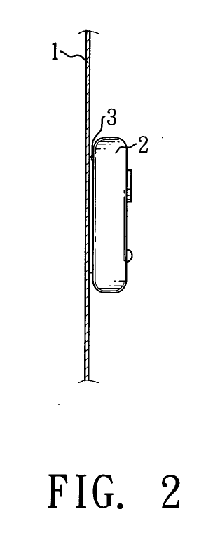

Please refer to FIG. 1 and FIG. 2, which are schematic, elevational view of the present invention and lateral view showing the combination of machine and card of the present invention. In the present invention, a machine 2 is located on the card 1, the combining method between machine 2 and card 1 can be adhesion, clamping, and etc., so that the machine 2 is therefore demountable from the card 1. In this preferred embodiment, an adhesive 3 is applied to backside of the machine 2 to adhere the machine 2 to the card 1.

A recording device 21, a playback device 22, and a storage device 23 are located on the machine 2. The recording device 21 comprises a microphone 211, a camera lens 212, and a recording button 213 for enabling card sender to take picture and record dynamic video/audio.

The playback device 22 comprises a speaker 221, a monitor 222, and a playback button 223 to enable the card receiver to show the video/audio recorded by the card sender.

The storage device 23 is used for storing the recorded video/audio, wherein the storage device 23 can be an embedded memory or an external memory card. The recorded video/audio can be transmitted to apparatus, for example, computer, through a transmitting interface for editing and modifying. With the use of the storage device the content for expression can be changed by renewing the file stored in the storage device.

According to the aforementioned mention, the card sender is able to pre-record the expressing demanded image and voice of himself, his family, or any thing by the use of the recording device 21 which is located on the card 1 in lively and emotional ways to convey his greeting. When the card receiver receives this card, the card sender's image will be shown on the monitor 222 of the playback device 22, and the card sender's live and stereophonic voice will be broadcasted by the speaker 221 as reality or face to face, so as to provide the card receiver with a live reality feeling, as if face to face, and to achieve a lively linkage between the card sender and receiver, and to bring an impressive convey effect into fully play.

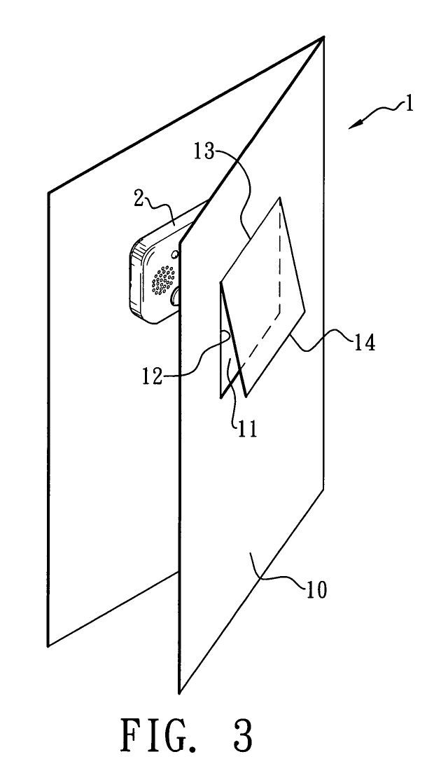

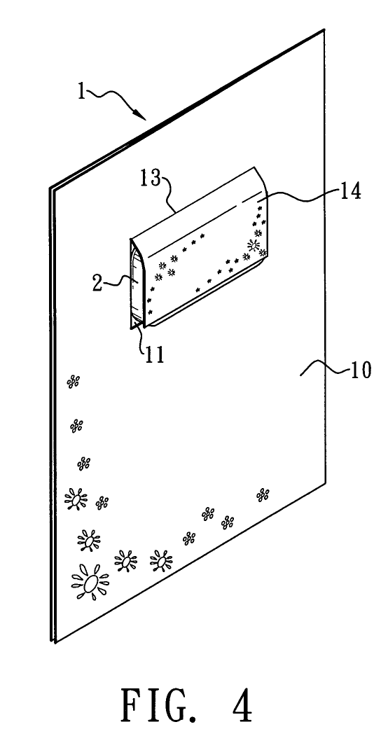

Please refer to FIG. 3 and FIG. 4, which are schematic diagrams showing the second preferred embodiment of the present invention, wherein an opening 11 is located on the cover surface 10 of the card 1 at a position corresponding to the machine 2. The opening 11 is formed by cutting the cover surface along with a continuous cutting line 12 and remaining a connection position 13, so as to form a cover 14 by turning over the cut region, namely, the opening 11, along with the connection position 13, and the machine 2 is protrusive located on the opening 11 when the cover surface 10 of the card 1 is covered closely with the bottom surface. The cover 14 provided the machine 2 with the function of protection and decoration.

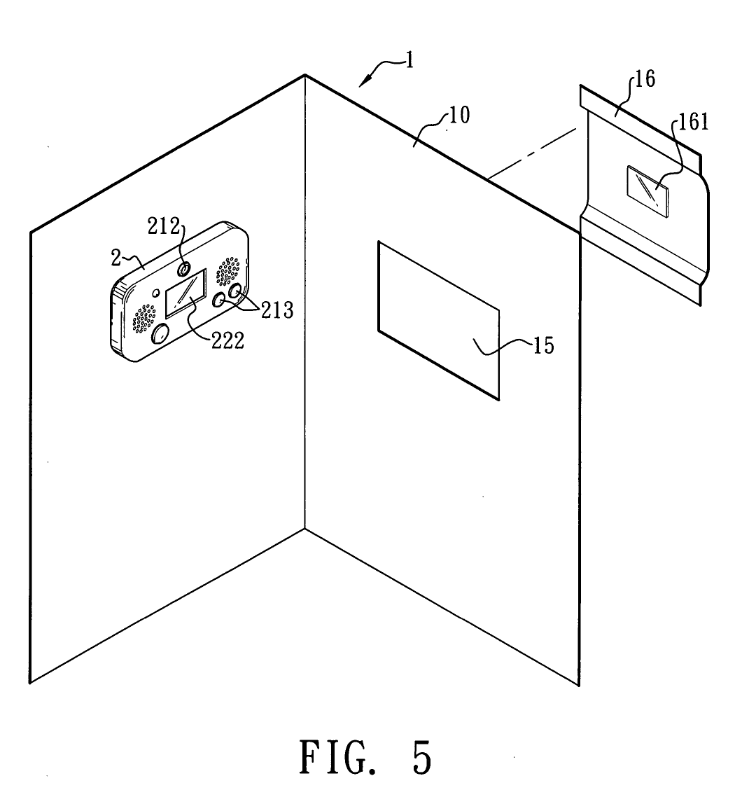

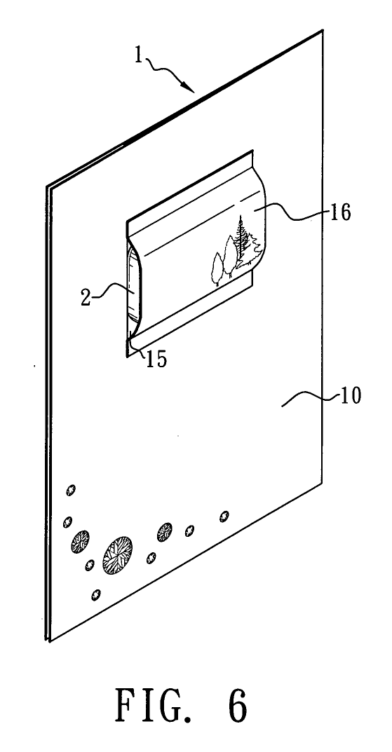

FIG. 5 and FIG. 6 are schematic diagrams showing the third preferred embodiment of the present invention, wherein an embedded hole 15 is located on the cover surface 10 of the card 1 at a position corresponding to the machine 2, so that the machine 2 is protrusive located on the embedded hole 15 when the card 1 is closed, and the card 1 is therefore closed closely. A decoration board 16 for decoration is coupled with the embedded hole 15 to cover the raised machine 2. A protection layer 161 is located on the inner surface of the decoration board 16 to shield the monitor 222 of the machine 2.

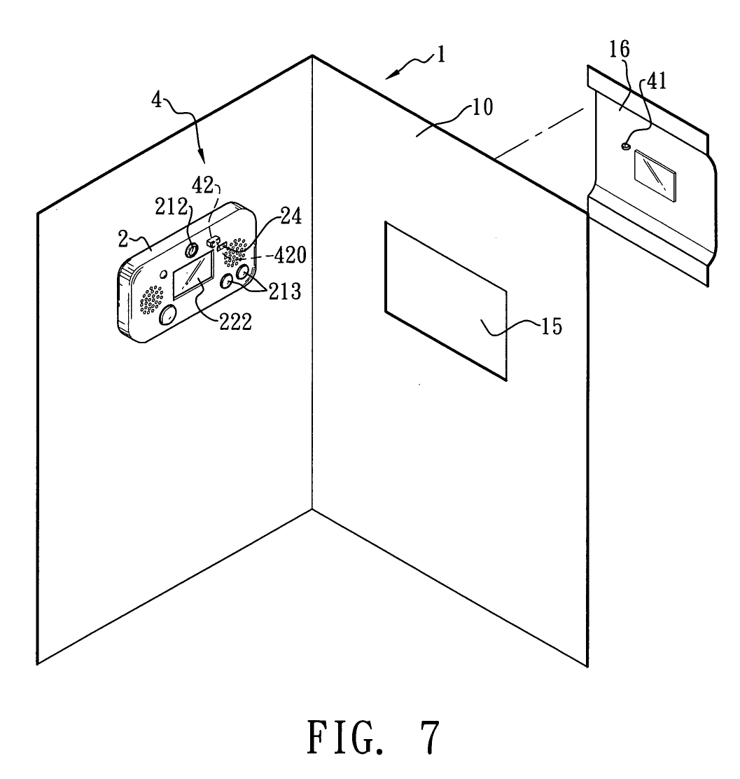

FIG. 7 is schematic diagram showing the fourth preferred embodiment of the present invention, wherein a switch device 4 is located on the card 1, so as to show the recorded video/audio automatically as the card 1 is opened and stop the showing of video/audio as the card 1 is closed. The switch device 4 comprises a trigger 41 and a micro switch 42. The trigger 41 is protrusive located on the inner side of the cover surface 10, and in this preferred embodiment the trigger 41 is located on the decoration board 16. The micro switch 42 which is equipped with an elongated arm 420 is located inside the machine 2, wherein a hole 24 is located on the machine 2 at a position corresponding to the micro switch 42 so that the trigger 41 will be extended through the hole 24 to press/touch the elongated arm 420 of the micro switch 42 for producing a stopping signal to stop the showing of the video/audio when the card 1 is closed. A playing signal is produced when the trigger 41 leaves the micro switch 42 to show the pre-recorded video/audio automatically. Accordingly, the video/audio will be showed right away without any operation when the card receiver opens the card. Alternatively, the show will be stopped when the card receiver closes the card. A simple and convenient method for using is therefore provided.

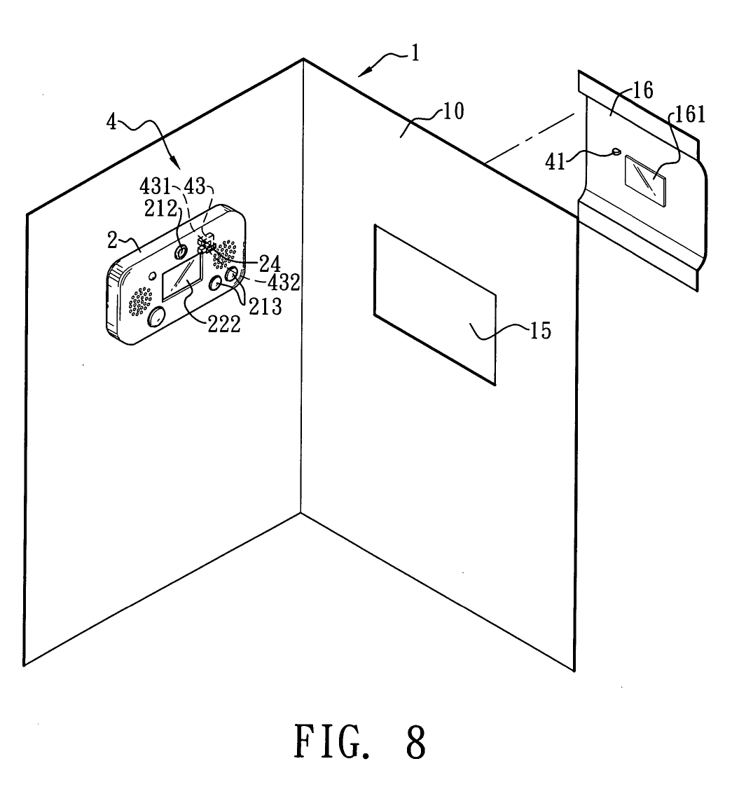

FIG. 8 is schematic diagram showing the fifth preferred embodiment of the present invention. In the aforementioned fourth preferred embodiment the switch device 4 comprises a trigger 41 and an optical switch 43, the trigger 41 is protrusive located on the cover surface 10 of the card. In the fifth preferred embodiment the trigger 41 is located on the decoration board 16. The optical switch 43 is located inside the machine 2, and a light emitting unit 431 and a light receiving unit 432 are located on both sides of the trench of the optical switch 43, respectively. When the card is closed the trigger 41 of the cover surface 10 will be extended through the hole 24 and inserted into the trench of the optical switch 43 to block the light-source for producing a stopping signal to stop the showing of the video/audio. When the card 1 is opened the trigger 41 will leave the trench of the optical switch 43 without blocking light-source. A starting signal is therefore produced for auto-starting the showing of the video/audio recorded by the card sender. Accordingly, the video and audio recorded by the card sender will be showed automatically when the card receiver opens the card without any operation. And, the showing of video/audio will be stopped when the card is closed. A simple and convenient method for using is therefore provided.

Because the machine of the invention is combined with the card by adhesion or clamping, the machine for video/audio recording and playback can be demounted for reuse, when the card is viewed, and the using method with more variety is therefore provided.

By the use of the storage device, user can change the content of the recorded video/audio at any time so as to apply to different conditions repeatedly, and the deficiency of the music card of only repeating the same content is resolved. The present invention can transmit the video/audio message file, which is pre-edited by computer, to the storage device. The file is then shown by the monitor of the card so as to provide the production method of video/audio card with more variety.

Therefore, as is understood by a person skilled in the art, the present invention achieves the aforementioned purpose according to the above description and satisfies requirements of patent law. The patent application is therefore submitted.

The foregoing preferred embodiments are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

1. A card for audio/video recording and playback, in which a machine is combined with the card, the machine comprising a recording device, a playback device, and a storage device, the recording device comprising a microphone, a camera lens, and a recording button, the playback device comprising a speaker, a monitor, and a playback button, for enabling a card sender to record his video and audio at random and to provide the card with stereophonic and dynamic text, voice and image.

2. The card according to claim 1, wherein the storage device is a memory card.

3. The card according to claim 1, wherein the machine is adhered to the card by adhesive.

4. The card according to claim 1, wherein an opening is located on a cover surface of the card at a position corresponding to the machine, the opening is formed by cutting the cover surface along with a continuous cutting line and remaining a connection position, so as to form a cover by turning over the cut region, namely, the opening, along with the connection position, and the machine is protrusive located on the opening when the card is closed, and the card is therefore closed closely.

5. The card according to claim 1, wherein an embedded hole is located on a cover surface of the card at a position corresponding to the machine, and a decoration board is combined with the embedded hole.

6. The card according to claim 5, wherein a protection layer is located on an inner side of the decoration board.

7. The card according to claim 1, wherein a switch device is located on the card, the switch device comprises a trigger and a micro switch, the trigger is protrusive located on the inner side of the cover surface of the card, the micro switch equipped with an elongated arm is located inside the machine, a hole is located on the machine at a position corresponding to the micro switch, and the trigger is therefore extended through a hole to press/touch the elongated arm of the micro switch for producing a stopping signal to stop the video/audio showing of the card automatically when the card is closed

8. The card according to claim 1, wherein a switch device is located on the card, the switch device comprises a trigger and an optical switch, the trigger is protrusive located on an inner side of the cover surface of the card, the optical switch having a light emitting unit and a light receiving unit is located inside the machine, a hole is located on the machine at a position corresponding to the optical switch, and the trigger is therefore extended through the hole to block a light-source for producing a stopping signal to stop the video/audio showing of the card automatically when the card is closed.

9. The card according to claim 5, wherein a switch device is located on the card, the switch device comprises a trigger and a micro switch, the trigger is protrusive located on the inner side of the cover surface of the card, the micro switch equipped with an elongated arm is located inside the machine, a hole is located on the machine at a position corresponding to the micro switch, and the trigger is therefore extended through a hole to press/touch the elongated arm of the micro switch for producing a stopping signal to stop the video/audio showing of the card automatically when the card is closed.

10. The card according to claim 5, wherein a switch device is located on the card, the switch device comprises a trigger and an optical switch, the trigger is protrusive located on an inner side of the cover surface of the card, the optical switch having a light emitting unit and a light receiving unit is located inside the machine, a hole is located on the machine at a position corresponding to the optical switch, and the trigger is therefore extended through the hole to block a light-source for producing a stopping signal to stop the video/audio showing of the card automatically when the card is closed.
